(19) United States
(12) Patent Application Publication
(10) Pub. No.: US 2015/0332250 A1
(43) Pub. Date: Nov. 19, 2015

(54) SYSTEMS AND METHODS FOR SECURITY FEATURES FOR RETAIL CARDS EXCHANGE

(71) Applicant: Brian Culwell, Spring, TX (US)

(72) Inventor: Brian Culwell, Spring, TX (US)

(21) Appl. No.: 14/714,386

(22) Filed: May 18, 2015

Related U.S. Application Data
(60) Provisional application No. 61/994,927, filed on May 18, 2014.

(51) Int. Cl. G06Q 20/34; G06Q 20/28

(52) U.S. Cl. CPC G06Q 20/349; G06Q 20/342; G06Q 20/28

(57) ABSTRACT

Embodiments may be configured to determine a balance associated with a first gift card for a first retailer, void the first gift card, and issue a second gift card associated with the first retailer. Embodiments may be utilized by users on a gift card exchange to ensure, validate, and/or verify that the gift cards purchased, sold, and/or exchanged are new and unused gift cards with the indicated balance.

### CROSS-REFERENCE TO RELATED APPLICATIONS

This application claims a benefit of priority under 35 U.S.C. §119 to Provisional Application No. 61/994,927 filed on May 18, 2014, which is fully incorporated herein by reference in its entirety.

### BACKGROUND INFORMATION

1. Field of the Disclosure

Examples of the present disclosure are related to systems and methods for verifying balances on a gift card. Specifically, embodiments are related to verifying gift cards on exchange systems by issuing a new gift card to a user.

2. Background

Many retailers or service providers offer customers the option of purchasing gift cards for a predetermined value. The gift cards allow users to subsequently purchase merchandise or services. Although, the gift cards themselves may not have intrinsic monetary value, the gift cards may have security information, such as embedded code, identification number, security number, expiration date, etc. This information is later used by a gift card processing device to determine a monetary equivalent associated with the gift card.

Frequently, gift cards are purchased as gifts by a gift card buyer and given to a gift card recipient. Instead of the gift card buyer determining what exact item the gift card recipient desires to purchase, the gift card recipient may use the gift card to purchase desired merchandise or services.

However, a gift card recipient may receive gift cards from retailers that they do not desire to purchase any good or services from. Therefore, a gift card recipient may become the holder of a plurality of gift cards associated with undesirable retailers.

Conventionally, if the holder of the plurality gift cards has gift cards associated with undesirable retailers, the gift card holder may offer to sell or trade the undesirable gift cards on gift card exchanges. However, the purchaser or recipient trader on conventional gift card exchanges may not know: 1) if the gift card is valid, 2) the balance on the gift card, 3) if others know the security information associated with the gift card, etc.

Accordingly, needs exist for more efficient and effective systems and methods to manage the validity of gift cards.

### SUMMARY

Embodiments described herein are directed towards systems and methods for verifying the balances associated with different retailers or service providers (referred to hereinafter individually and collectively as “retailer”). In embodiments, a gift card may relate to any restricted monetary equivalent that is associated with a retailer, such as a gift card, card including a monetary equivalent associated with a retailer or a plurality of retailers, a physical gift card, discount cards, prepaid card, stored value card, etc. (referred to hereinafter individually and collectively as “gift card”).

Embodiments may be configured to determine a balance associated with a first gift card for a first retailer, void the first gift card, and issue a second gift card associated with the first retailer. Embodiments may be utilized by users on a gift card exchange to ensure, validate, and/or verify that purchased, sold, or exchanged gift cards are new and unused gift cards with the indicated balance.

The gift card server may include a transfer module, balance module, exchange module, a distribution module, and void module.

The transfer module may be configured to allow a first user to buy, exchange, and/or sell a gift card associated with a first retailer. The transfer module may also be configured to allow the first user to buy, exchange, and/or sell a gift card associated with the first retailer and/or a second retailer.

The balance module may be configured to utilize information associated with the first gift card to determine the balance for a corresponding first gift card.

The exchange module may be configured to create a second gift card. The second gift card may include a balance that is based on the balance associated with the first gift card, wherein the first and second gift cards are associated with the first retailer. The exchange module may also be configured to create the second gift card with different security information than the first gift card.

The distribution module may be configured to transmit the second gift card to the first user and/or a second user. Therefore, users may use the gift card server to validate their currently owned gift cards and/or use the gift card server to validate gift cards being exchanged, sold, and/or purchased.

The void module may be configured void the first gift card responsive to the exchange module creating the second gift card. By the void module voiding the first gift card the balance associated with the first gift card may be zero.

These, and other, aspects of the invention will be better appreciated and understood when considered in conjunction with the following description and the accompanying drawings. The following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts one topology allowing retailers and/or users to determine balances associated with outstanding gift cards, according to an embodiment.

FIG. 2 depicts a gift card server, according to an embodiment.

FIG. 3 depicts a method for validating gift cards, according to an embodiment

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Embodiments described herein are configured to determine a balance associated with a first gift card for a first retailer, void the first gift card, and issue a second gift card associated with the first retailer. Embodiments may be utilized by users on a gift card exchange to ensure, validate, and/or verify that the gift cards purchased, sold, and/or exchanged are new and unused gift cards with the indicated balance.

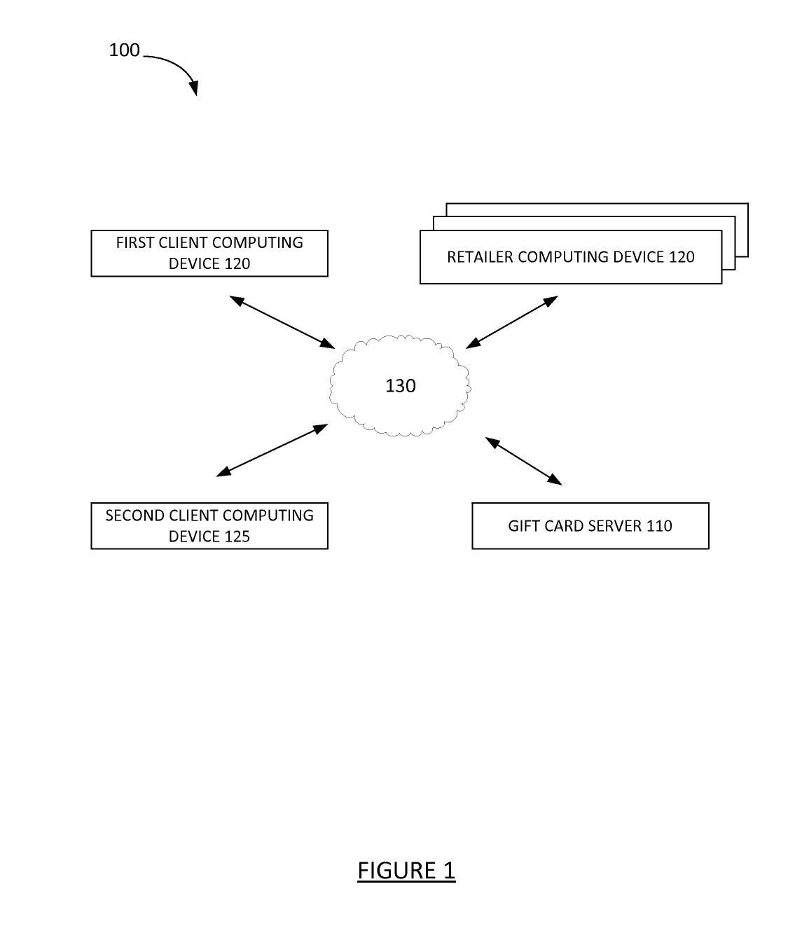

Turning now to FIG. 1, FIG. 1 depicts one topology allowing retailers and/or users to determine balances associated with outstanding gift cards. Topology 100 may include a gift card server 110, first client computing device 120, second client computing device 125, and a retailer computing device 140. The elements depicted in topology 100 may be communicatively coupled to each other over network 130. In other embodiments, elements depicts in topology within a first device (i.e. gift card server 110) may be located in a second device (i.e. first client computing device 120). Accordingly, FIG. 1 is a non-limiting network topology 100 for determining balances associated with outstanding gift cards.

Network 130 may be a wired or wireless network such as the Internet, an intranet, a LAN, a WAN, a cellular network or another type of network. It will be understood that network 130 may be a combination of multiple different kinds of wired or wireless networks. Network 130 may also be comprised of telephone lines, fiber optic cables, internet cables, microwave transmission links, cellular networks, communications satellites, undersea telephone cables, which may be interconnected by switching centers. The switching centers associated with network 130 may allow any telephone or device with a processor to simulate a telephone to communicate with each other. It will be understood that network 130 may be a combination of multiple different kinds of wired or wireless networks, which may include analog telephone systems and/or digital telephone systems.

Gift card server 110 may be a computing device, such as a general hardware platform server configured to support mobile applications, point of sale (POS) devices, software, and the like executed on client computing devices 120, 125 and/or retailer computing device 140. Gift card server 110 may include physical computing devices residing at a particular location or may be deployed in a cloud computing network environment. In this description, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). Gift card server 110 may include any combination of one or more computer-usable or computer-readable media. For example, gift card server 110 may include a computer-readable medium including one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device.

Gift card server 110 may also be configured to allocate and provision computing resources based on a processing load on gift card server 110. The processing load may be associated with a number of users simultaneously desiring to verify balances on gift cards, a number of gift cards having their balances verified, a number of gift cards being issued, and/or a number of gift cards being voided. Gift card server 110 may be configured to balance a processing load by distributing workloads across multiple computing resources, wherein gift card server 110 may dynamically balance the load using services offered by various hardware devices across network 130. By provisioning load balances associated with different hardware computing devices across network 130, gift card server 110 may increase the speed of verifying balances for gift cards, while also lowering costs associated with verifying balances for gift cards. In embodiments, gift card server 110 may be configured to scale up and/or down based on the processing load by efficiently and dynamically allocating the processing load across nodes evenly.

In embodiments, gift card server 110 may be configured to receive requests from client computing devices 120, 125 to issue new, verified gift cards. The requests may be in to form of exchange requests to exchange a first gift card associated with a first retailer with a second gift card associated with the first retailer, a selling request to transmit a new, verified gift card with a balance associated with the first gift card to a second user, a purchase request to receive a new, verified gift card with a desired balance, and/or a transfer request to transfer a first gift card associated with a first retailer from a first retailer with a second gift card associated with the first retailer to a second user.

First client computing device 120 may be a laptop computer, desktop computer, smart phone, tablet computer, personal data assistant, or any other type of device with a hardware processor that is configured to process instructions and connect to network 130 and/or other forms of networks. First client computing device 120 may be configured receive gift card information from a user. The gift card information may include a user name, retailer information, identification number, security code, contact information, expiration date, pin number, etc. In embodiments, first client computing device 120 may store the gift card information locally at first client computing device 120. First client computing device 120 may be utilized by a first user to exchange, transfer, buy, and/or sell a gift card, wherein the first user may be ensured that balance associated with the gift card is ensured. The first user may utilize first client computing device 120 to receive a monetary value, promotion, coupon, and/or a new gift card in exchange for exchanging, transferring, buying, and/or selling a gift card. In embodiments, the first user may exchange, transfer, buy and/or sell a first gift card associated with a first retailer to a second user. Responsive to the transaction, the first and/or second user may receive a new, second verified gift card associated with the first retailer.

Second client computing device 125 may be a laptop computer, desktop computer, smart phone, tablet computer, personal data assistant, or any other type of device with a hardware processor that is configured to process instructions and connect to network 130 and/or other forms of networks. Second client computing device 125 may be configured receive gift card information from a second user. Second client computing device 125 may be utilized by a second user to exchange, transfer, buy, and/or sell a gift card, wherein the second user may be ensured that balance associated with the gift card is ensured. The second user may utilize second client computing device 125 to receive a monetary value, promotion, coupon, and/or a new gift card in exchange for exchanging, transferring, buying, and/or selling a gift card. In embodiments, the second user may exchange, transfer, buy and/or sell a first gift card associated with a first retailer to the first user. Responsive to the transaction the first and/or second user may receive a new, second verified gift card associated with the first retailer. In embodiments, the identification information associated with the second verified gift card may be independent and unrelated to the identification information associated with the first gift card.

Retailer computing device 140 may be a laptop computer, desktop computer, point of sale computing device, smart phone, tablet computer, personal data assistant, or any other type of device with a hardware processor that is configured to process instructions and connect to network 130 and/or other forms of networks. Retailer computing device 140 may be configured to receive gift card information associated with a first gift card, determine a balance of the first gift card associated with a first retailer, void the first gift card, and transmit a second gift card associated with the first retailer.

The gift card information may include a user name, retailer information, identification number, protection code, contact information, expiration date, etc. The second gift card may include second gift card information which is different from the gift card information associated with the first gift card, and the balance associated with the second gift card may be based on the balance associated with the first gift card. In embodiments, the balance associated with the second gift card may be equal to or less than the balance associated with the first gift card, wherein the difference between balances may be based on a verification fee to determine the balance on the first gift card, create the second gift card, and void the first gift card. In embodiments, responsive to the second gift card being issued, the first gift card information may be cleared from a memory device associated with retailer computing device 140.

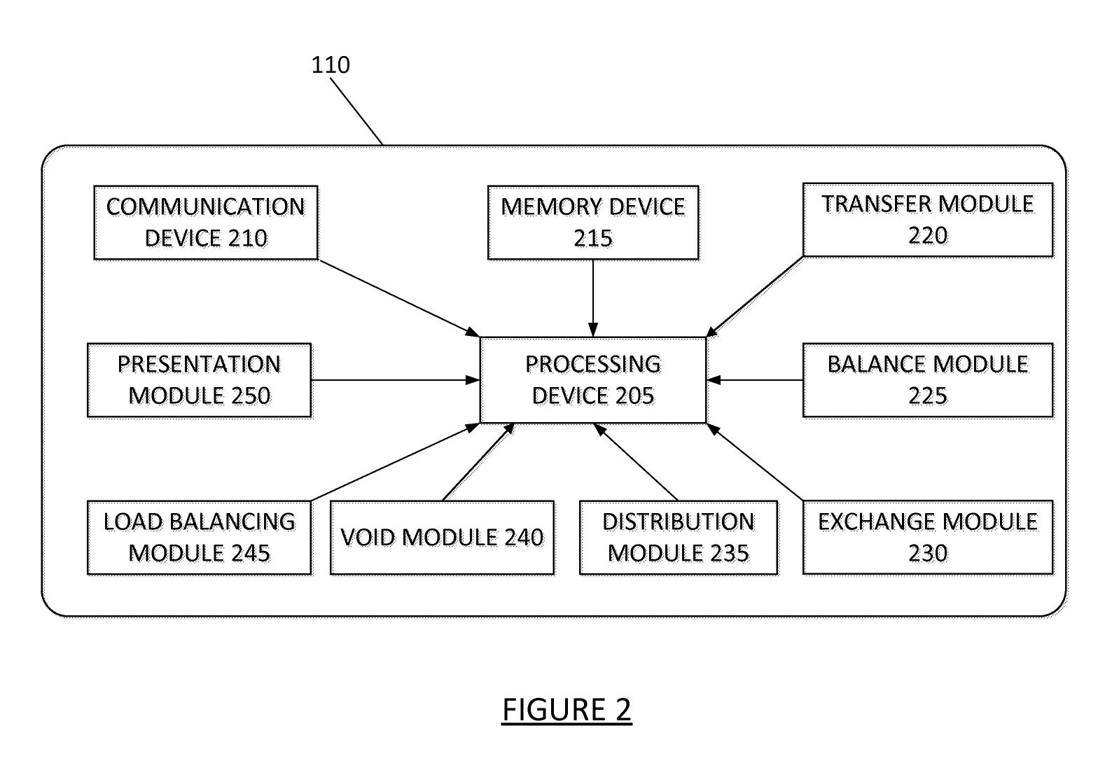

FIG. 2 depicts one embodiment of gift card server 110. Gift card server 110 may include a processing device 205, communication device 210, memory device 215, transfer module 220, balance module 225, exchange module 230, a distribution module 235, void module 240, a load balancing module 245, and presentation module 250. Elements depicts in FIG. 2 may also be located at a retailer computing device 140. Additionally, gift card server 110 may be a device that is independent of retailer computing device 140 and/or any retailer. Accordingly, gift card server 110 may be configured to exchange gift cards from a plurality of different retailers.

Processing device 205 may include memory, e.g., read only memory (ROM) and random access memory (RAM), storing processor-executable instructions and one or more processors that execute the processor-executable instructions. In embodiments where processing device 205 includes two or more processors, the processors may operate in a parallel or distributed manner. Processing device 205 may execute an operating system of gift card server 110 or software associated with other elements of gift card server 110. For example, processing device 205 may be configured to concurrently issue a second gift card with second gift card information, while removing, from memory device 215, first gift card information associated with a first gift card. Therefore, while the second gift card is issued, there will be no overlapping periods when the first gift card and the second gift card may be issued.

Communication device 210 may be a device that gift card server 110 to communicate with another device over network 130. Communication device 210 may include one or more wireless transceivers for performing wireless communication and/or one or more communication ports for performing wired communication over the internet, PSTN, etc. Communication device 210 may be configured to communicate data over a plurality of different standard and/or protocols. Furthermore, responsive to communication device 210 receiving a request to issue a second gift card, communication device 210 may transmit a hold request for the first gift card to retailer computing device 140. The hold request may indicate that no transactions associated with the first gift card may be issued. The hold request may be stored locally within cache memory of retailer computing device 140, and may be removed from the cache memory responsive to receiving a remove hold request.

Memory device 215 may be a device that stores data generated or received by gift card server 110. Memory device 215 may include, but is not limited to a hard disc drive, cache memory drive, an optical disc drive, and/or a flash memory drive. In embodiments, memory device 215 may be configured to store information received from a client computing device 120 and/or retailer computing device 140. The information stored within memory device 215 may be accessed by processing device 205, communication device 210, and/or modules 220, 225, 230, 235, 240, 245, 250. In embodiments, memory device 215 may be configured to store gift card information within a cache memory, such that an additional round trip request is not required to obtain the gift card information.

Transfer module 220 may be a hardware processing device configured to allow a first user to buy, exchange, and/or sell a gift card associated with a first user. Transfer module 220 may be configured to receive a buy request, an exchange request, and/or a sell request (referred to hereinafter collectively and individually as “exchange request”).

Transfer module 220 may be configured to receive a buy request from first client computing device 120 indicating that the user desires to buy a first gift card associated with a first retailer. Transfer module 220 may be configured to receive an exchange request from first client computing device 120 indicating that the user desires to exchange the first gift card associated with a first retailer with a second gift card associated with the first retailer.

Transfer module 220 may also be configured to receive a sell request indicating that a first user of first client computing device 120 desired to transfer a balance associated with a first gift card to a second user of client computing device 125. Responsive to receiving a transfer request from first client computing device 120, transfer module 220 may transmit the transfer request to balance module 225. Additionally, responsive to receiving the transfer request from first client computing device 120 while balance module 225 is determine the balance of the first gift card, communication device 210 my simultaneously communicate the hold request to retailer computing device 140. In embodiments, the hold request may have a time stamp with a time period, wherein during the time period associated with the hold request the first gift card may only be used by gift card server 110. The first gift card may be utilized by gift card server 110 based on a unique identifier associated with gift card server (i.e. IP address, MAC address, etc.) that may be transmitting to retailer computing device 140 along with the hold request.

Balance module 225 may be a hardware processing device configured to receive a transfer request from transfer module and to determine the balances for gift cards associated with the transfer request. Balance module 225 may be configured to determine the balances of the gift cards in a plurality of different ways and/or functions. For example, in one embodiments balance module 220 may determine the balances of the gift cards as described in U.S. Application No. 61/989,293, titled “SYSTEMS AND METHODS FOR VERIFYING BALANCES ON RETAIL CARDS,” which is hereby incorporated by reference in its entirety.

Balance module 225 may be configured to parse the gift card information associated with a gift card to determine which retailer is associated with the gift card. For example, a first retailer may include an identification number having a first string of numbers, and a second retailer may include an identification number having a second string of numbers. Utilizing the gift card information balance module 225 may transmit a balance request to a retailer computing device 140 associated with the gift card. Responsive to transmitting the balance request, balance module 225 may determine a monetary equivalent associated with the gift card. The received balance may be stored within a cache memory of balance module 225, which may be accessed by exchange module 225. By storing the balance of the first gift card locally within gift card server 110 additional round trip delays may not be required.

Exchange module 230 may be a hardware processing device configured to create a second gift card with a balance that is based on the balance associated with the first gift card, wherein the second gift card may be associated with the same retailer as the first gift card. Responsive to balance module 225 determining the balance associated with the first gift card, exchange module 230 may be configured to create the second gift card, wherein the second gift card may have different gift card information that the first gift card. In embodiments, the second gift card may be created by gift card server 110 performing a transaction with retailer computing device 140 utilizing gift card server's 110 unique identifier and the balance of the gift card.

Furthermore, the gift card information associated with the second gift card may be independent of the first gift card. Utilizing exchange module 230, if a first user of first client computing device 120 desires to buy, exchange, and/or transfer ownership of the first gift card to a second user of second computing device 125, the second user may be assured that the first user or any other user does not have access to the gift card information associated with the first gift card. The second gift card may be created while the hold request is still pending at the retailer computing device 140. Furthermore, exchange module may be configured to transmit a delete request to retailer computing device 140 responsive to the second gift card being created. Thus, the first gift card may not be able to be accessed while completing the transaction for the first gift card.

In embodiments, the first user may accidently present gift card information associated with a first gift card on the internet (e.g. via a picture on a social media site), which may comprise the value of the first card. The first user may use exchange module 220 to remotely exchange the first gift card associated with a first retailer for a new gift card associated with the first retailer. Therefore, the new gift card may include uncompromised gift card information. In embodiments, exchange module 240 may be configured to create a second gift card with the new gift card information by transmitting a creation request to a corresponding retailer computing device 140, wherein the creation request may instruct retailer computing device 140 to perform actions to create and transmit the gift card to exchange module 230.

Distribution module 235 may be a hardware processing device configured to distribute the second gift card created by exchange module 220 to a corresponding user. Responsive to exchange module 220 receiving a second gift card, distribution module 235 may be configured to determine the type of transfer request associated with the second gift card (e.g. a buy request, exchange request, and/or sell request), distribution module 235 may determine if the second gift card should be transmitted to the first user or a second user.

Void module 240 may be a hardware processing device configured to void, nullify, erase, etc. (referred to hereinafter collectively and individually as “void”) gift card information associated with the first gift card. Void module 240 may void the gift card information associated with the first gift card responsive to receiving the transfer request, while the hold request is pending. In embodiments, void module 240 may be configured to void the gift card information associated with the first gift card by transmitting a void request to a corresponding retailer computing device 140, wherein the void request may instruct retailer computing device 140 to perform actions to void the first gift card.

Load balancing module 245 may be configured to balance a processing load of gift card server 110 across different hardware elements on network 130. The load may be balanced by allocating, scaling, adding, and deleting, and provisioning hardware processing resources based on the processing load on gift card server 110. The processing load may be associated with a number of users simultaneously desiring to exchange gift cards, create new gift cards, void balances of gift cards, etc. Load balancing module 245 may be configured to balance a processing load by distributing workloads across multiple computing resources, wherein gift card server 110 may dynamically balance the load using services offered by various hardware devices across network 130. By provisioning load balances associated with different hardware computing devices across network 130, Load balancing module 245 may increase the speed of verifying balances for gift cards, while also lowering costs associated with verifying balances for gift cards.

In embodiments, load balancing module 245 may be configured to scale up and/or down based on the processing load by efficiently and dynamically allocating the processing load across nodes evenly. To this end, when gift card server 110 has an increased load, load balancing module 245 may be configured to increase the amount of hardware processors allocated to the workload of gift card server 110, and when gift card server 110 has a decreased load, load balancing module 245 may be configured to decrease the amount of hardware processors allocated to the workload of gift card server 110. In further embodiments, the allocation or decommissioning of hardware processors associated with the load of gift card server 110 may be scheduled, wherein during normal business hours additional servers may be allocated to the workload, and during non-business hours the number of servers allocated to the workload may be reduced.

Presentation module 245 may be a hardware processing device configured to transmit content to be displayed at client computing devices 120, 125 and retailer computing device 140. Presentation module 245 may be configured to present an interface to a user so the user may enter a transfer request. Furthermore, presentation module 245 may be configured to present an interface to a user with gift card information associated with a first and/or second gift card.

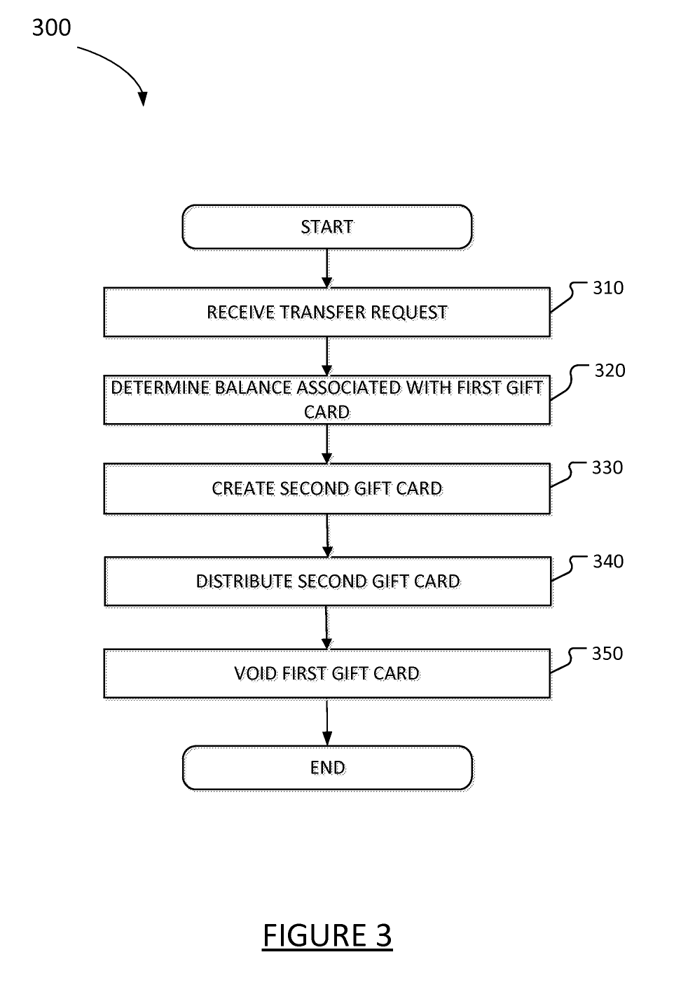

FIG. 3 illustrates a method 300 for validating gift cards. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 500.

At operation 310, a transfer request may be received. The transfer request may indicate that the first user desires to sell a first gift card in exchange for a monetary value, buy a first gift card, exchange the first gift card for a second gift card, transfer ownership of the first gift card to a second user, and/or a combination. Operation 310 may be performed by a transfer module that is the same as or similar to transfer module 220, in accordance with one or more implementations.

At operation 320, a balance associated with the first gift card for a first retailer may be determined. The balance associated with the first gift card may be determined by parsing gift card information (e.g. identification information associated with the gift card) to determine that the first retailer supplied the gift card. Utilizing the gift card information, a balance request may be transmitted to a retailer computing device associated with the first retailer, and a monetary identifier of the balance of the first gift card may be received from the retailer computing device. Operation 320 may be performed by a balance module that is the same as or similar to balance module 220, in accordance with one or more implementations.

At operation 330, a second gift card may be created. The second gift card may have a balance that is based on the balance of the first gift card, and the second gift card may be associated with the same retailer as the first gift card. The gift card information associated with the second gift card may be independent of the first gift card. Operation 330 may be performed by an exchange module that is the same as or similar to exchange module 230, in accordance with one or more implementations.

At operation 340, the second gift card may be distributed to a corresponding user. The second gift card may be distributed to the first user who may have owned the first gift card or a second user desiring the purchase, trade for, etc. the first gift card. Therefore, the receiving user may receive the second gift card which may not have uncompromised gift card information. Operation 340 may be performed by a distribution module that is the same as or similar to distribution module 230, in accordance with one or more implementations

At operation 350, the gift card information associated with the first gift card may be voided. The gift card information associated with the first gift card may be voided responsive to exchanging the first gift card for the second gift card. Operation 350 may be performed by a void module that is the same as or similar to void module 245, in accordance with one or more implementations

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present embodiments may take the form of an entirely hardware embodiment, an entirely software embodiment (including firmware, resident software, micro-code, etc.), or an embodiment combining software and hardware aspects that may all generally be referred to herein as a “module” or “system.” For example, any device described as a module may be a hardware device. Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

The flowcharts and block diagrams in the flow diagrams illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagrams.

What is claimed is:

1. A system for exchanging gift cards, the system comprising:
a first physical gift card including first gift card information, the first gift card including a first balance and gift card information including a user name, a retailer identification, an identification number;
a transfer processing device configured to receive a sell request to transfer the first balance associated with the first gift card from a first user to a second user;
a balance processing device configured to determine the first balance responsive to receiving the sell request;
an exchange processing device configured to create a second gift card with a second balance, the second balance being associated with the first balance, the second gift card including second gift card information, the second gift card information being independent of the first gift card information, wherein responsive to creating the second gift card the exchange processing device is configured to delete the first gift card information from a memory device; and
a distribution device configured to distribute the second gift card to the second user, wherein the first gift card information is deleted from the memory device before distributing the second gift card to the second user.

2. The system of claim 1, wherein the balance of the first gift card is determined utilizing the first gift card information.

3. The system of claim 1, wherein the first gift card and the second gift card are associated with the same retailer.

4. The system of claim 1, further comprising:
a load balancing processing device configured to allocate and decommission hardware processing resources based on a processing load, wherein the processing load is based on a number of requests for exchanging gift cards.

5. The system of claim 4, wherein a plurality of gift cards may be exchanged simultaneously, wherein when the plurality of gift cards are exchanged simultaneously the processing load increases.

6. The system of claim 1, wherein the first gift card is not co-pending with the second gift card.

7. The system of claim 1, wherein the transfer processing device is configured to transmit a hold request with the sale request, the hold request including a time stamp, a time period, and a unique identifier.

8. The system of claim 7, wherein during the time period the first gift card cannot be utilized by a computing device that is not associated with the unique identifier.

9. The system of claim 8, wherein the hold request is stored at a retailer computing device associated with a retailer.

10. The system of claim 1, wherein the second gift card is created by performing a transaction with a retailer computing device utilizing the first gift card information.

11. A method for exchanging gift cards, the system comprising:
receiving first gift card information associated with a first physical gift card, the first gift card including a first balance and gift card information including a user name, a retailer identification, an identification number;
receiving a sell request to transfer the first balance associated with the first gift card from a first user to a second user;
determining the first balance responsive to receiving the sell request;
creating a second gift card with a second balance, the second balance being associated with the first balance, the second gift card including second gift card information, the second gift card information being independent of the first gift card information;
deleting the first gift card information on a memory device responsive to creating the second gift card; and
distributing the second gift card to the second user, wherein the first gift card information is deleted from the memory device before distributing the second gift card to the second user.

12. The method of claim 11, wherein the balance of the first gift card is determined utilizing the first gift card information.

13. The method of claim 11, wherein the first gift card and the second gift card are associated with the same retailer.

14. The method of claim 11, further comprising:
allocating and decommissioning hardware processing resources based on a processing load, wherein the processing load is based on a number of requests for exchanging gift cards.

15. The method of claim 14, further comprising:
exchanging a plurality of gift cards may be exchanged simultaneously, wherein when the plurality of gift cards are exchanged simultaneously the processing load increases.

16. The method of claim 11, wherein the first gift card is not co-pending with the second gift card.

17. The method of claim 11, comprising:
transmitting a hold request with the sale request, the hold request including a time stamp, a time period, and a unique identifier.

18. The method of claim 17, wherein during the time period the first gift card cannot be utilized by a computing device that is not associated with the unique identifier.

19. The method of claim 18, wherein the hold request is stored at a retailer computing device associated with a retailer.

20. The method of claim 11, wherein the second gift card is created by performing a transaction with a retailer computing device utilizing the first gift card information.
